(19) United States
(12) Patent Application Publication
(10) Pub. No.: US 2005/0089364 A1
(43) Pub. Date: Apr. 28, 2005

(54) Mounting device

(76) Inventor: Randall R. Geib, Manhelm, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/693,195

(22) Filed: Oct. 24, 2003

(51) Int. Cl. F16B 2/00

(52) U.S. Cl. 403/370

(57) ABSTRACT

A mounting device for coaxially anchoring a machine element upon a rotary shaft. The device fits between the interior bore of the machine element and the cylindrical surface of the shaft and is effective to position the element at any desired position longitudinally of the shaft and at any angular position circumferentially of the shaft. The device has inner and outer sleeves, the mating surfaces of which are similarly tapered so that relative axial displacement of the sleeves effects expansion and contraction of the interior bore and external surface of the combined elements. Rotation of a threaded nut at one end of the device effects the relative axial displacement of the inner and outer sleeves to afford expansion and contraction of the sleeves without excessively straining the material of the sleeves or the nut.

### FIELD OF THE INVENTION

The present invention relates to a mounting device for mounting a machine element upon a shaft in such a manner that the entire torque and/or thrust is transmitted between the machine element and the shaft without slippage due to the mounting. In particular, the device of the present invention provides an improved mounting device for mounting machine elements permitting infinitely-variable adjustment of the machine element on the shaft, both axially of the shaft and circumferentially thereof, and maintaining the machine element at a fixed, axial position after mounting on the shaft.

### BACKGROUND OF THE INVENTION

The use of devices for mounting machine elements, such as pulleys and gears, upon a shaft is well-known. One difficulty is that the known devices for mounting a machine element upon a cylindrical shaft are cumbersome to use. For example, some devices require assembly of multiple pieces and adjustment of several screws, and other devices require modification of the shaft on which the machine element is mounted.

Another difficulty frequently encountered relates to the need for precise positioning of the machine elements circumferentially on the shaft when the machine element is mounted upon the shaft. Specifically, it is desirable to position the machine element at a particular circumferential position and maintain the element at such position after the element is attached to the shaft. In addition, it is desirable to allow for the infinitely-variable adjustment of the machine element prior to attaching the element to the shaft.

### SUMMARY OF THE INVENTION

In accordance with the present invention, a mounting device is provided that is easy to use. The device enables the mounting of a machine element by simply tightening a single nut to effect frictional engagement and also to ensure disengagement by loosening the same nut. The nut operates to positively release the frictional engagement produced by tightening the nut. Furthermore, the design of the present unit is of simple construction and is relatively inexpensive to manufacture.

The present invention also solves the difficulty of maintaining the machine element at a fixed position. Once mounted, the device retains the machine element at a fixed, axial position relative to the shaft.

The present invention provides a device for coaxially mounting a machine element having a bore upon a shaft and it includes an outer sleeve for engaging the machine element, an inner sleeve for engaging the shaft and a nut for displacing the inner sleeve relative to the outer sleeve.

Preferably, the outer sleeve includes an outer surface configured to engage the machine element and a tapered internal surface. The taper of the internal surface is configured so that the it has a minor diameter adjacent a forward end of the outer sleeve and a major diameter spaced rearwardly from the forward end. The outer sleeve also includes a connector that is cooperable with a corresponding connector on the nut. Preferably, the connector substantially permanently secures the outer sleeve to the nut to prevent substantial axial displacement of the nut relative to the outer sleeve, while allowing rotation of the nut relative to the outer sleeve.

Preferably, the inner sleeve includes an interior bore configured to engage the shaft and a tapered external surface configured to cooperate with the internal surface of the outer sleeve. More specifically, the external surface has a minor diameter adjacent a forward end of the inner sleeve and a major diameter spaced rearwardly from the forward end of the inner sleeve. In addition, the inner sleeve includes threads that are cooperable with the threads on the nut.

Rotating the nut in a first direction displaces the inner sleeve forwardly relative to the nut, which displaces the major diameter of the external surface of the inner sleeve toward the minor diameter of the outer sleeve internal surface. Since the internal surface of the outer sleeve and the external surface of the inner sleeve have oppositely tapered surfaces, the axial displacement of the sleeves causes a wedging action. The wedging action causes the inner sleeve to contract against the shaft and the outer sleeve to expand against the bore of the machine element. Rotating the nut in a second direction displaces the inner sleeve rearwardly relative to the nut, thereby loosening the inner sleeve from the shaft and the outer sleeve from the bore of the machine element.

The present invention further provides a method for mounting a first element onto a second element. The method is particularly suited to mount a machine element onto a shaft. According to the method an inner sleeve is provided. Preferably, the inner sleeve has a tapered external surface, a threaded portion adjacent the rearward end of the sleeve and a bore that is cooperable with the shaft. In addition, an outer sleeve is provided. Preferably the outer sleeve has an internal bore that is tapered to cooperate with the external surface of the inner sleeve and an external surface that is cooperable with the bore of the machine element. In addition, a nut is provided, which is cooperable with the threaded portion of the inner sleeve. The outer sleeve is connected to the nut to impede substantial axial displacement of the outer sleeve relative to the nut while allowing rotation of the nut relative to the outer sleeve. The inner sleeve and outer sleeve are then positioned between the shaft and the bore of the machine element. The nut is then rotated in a forward direction to drive the inner sleeve forwardly relative to the nut and the outer sleeve, thereby displacing the forward end of the inner sleeve away from the nut, so that the tapered surface of the inner sleeve wedges apart the outer sleeve to connect the outer sleeve to the machine element and to connect the inner sleeve to the shaft. In addition, rotating the nut in a reverse direction drives the inner sleeve rearwardly relative to the nut and the outer sleeve to release the outer sleeve from the machine element and to release the inner sleeve from the shaft.

### BRIEF DESCRIPTION OF THE DRAWINGS

The foregoing summary, as well as the following detailed description of the preferred embodiments of the present invention, will be better understood when read in conjunction with the appended drawings, in which:

FIG. 1 is a perspective view of a mounting device;

FIG. 2 is a side cross-sectional view of the mounting device illustrated in FIG. 1 illustrated in combination with a machine element and a shaft;

FIG. 3 is a perspective cross-sectional view of the mounting device illustrated in FIG. 1; and

FIG. 4 is an exploded perspective view of the mounting device illustrated in FIG. 1

### DETAILED DESCRIPTION OF THE PREFERRED EMBODIMENTS

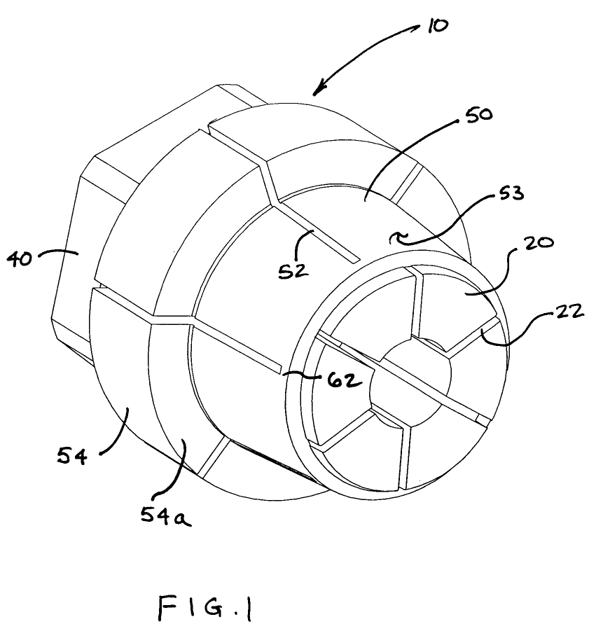

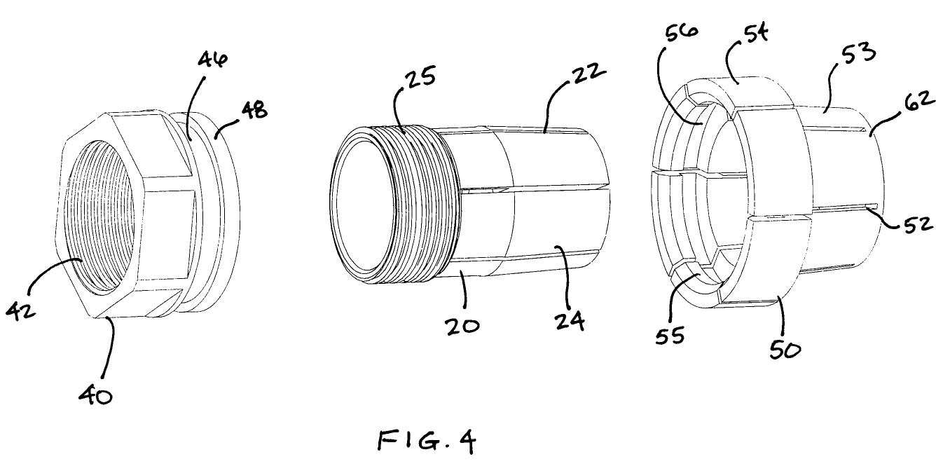

Referring now to the drawings and to FIGS. 1-4 specifically, a mounting device is designated generally 10. The mounting device is designed to mount a first element, such as a machine element 12, onto a second element, such as a shaft 15. The machine element 12 has a bore 13 that engages the external surface of the mounting device 10, and the shaft 15 has a surface that engages the internal surface of the mounting device 10 designed to mount the hub of a machine element 12 upon a cylindrical shaft 15 is illustrated. In the present instance, the machine element 12 has a smooth tapered bore 13 whose axis coincides with the axis of the cylindrical surface of the shaft 15. The mounting device is designed to be positioned between the machine element 12 and the shaft 15 and to be expanded to securely anchor the machine element 12 onto the shaft at any desired position axially of the shaft and any angular position circumferentially of the shaft.

The mounting device 10 includes an inner sleeve 20, an outer sleeve 50, and a locking nut 40. The external surface of the inner sleeve 20 is formed to cooperate with the inner surface of the outer sleeve as discussed further below. Specifically, the forward end of the inner sleeve has a frustoconical tapered external surface 24. The frustoconical surface 24 is configured so that the minor diameter is adjacent the forward edge of the inner sleeve and the major diameter is spaced rearwardly from the forward edge. In other words, the largest diameter of the frustoconical surface 24 is located intermediate the ends of the inner sleeve and the surface tapers inwardly as the surface extends toward the forward end of the inner sleeve. The external surface of the sleeve also includes an externally threaded portion 25 rearward of the frustoconical portion.

The inner sleeve 20 is tubular in form having an internal bore that cooperates with the external surface of the shaft 15. Specifically, if the external surface of the shaft is tapered or frustoconical, the internal surface of the inner sleeve has a cooperating tapered or frustoconical surface. In the present instance, the shaft is cylindrical, and the inner sleeve 20 has a cylindrical bore with a diameter that corresponds to the diameter of the shaft 15. Preferably, the bore of the inner sleeve is slightly greater in diameter than the shaft 15 to permit free sliding movement of the inner sleeve 20 on the shaft 15 both axially and circumferentially.

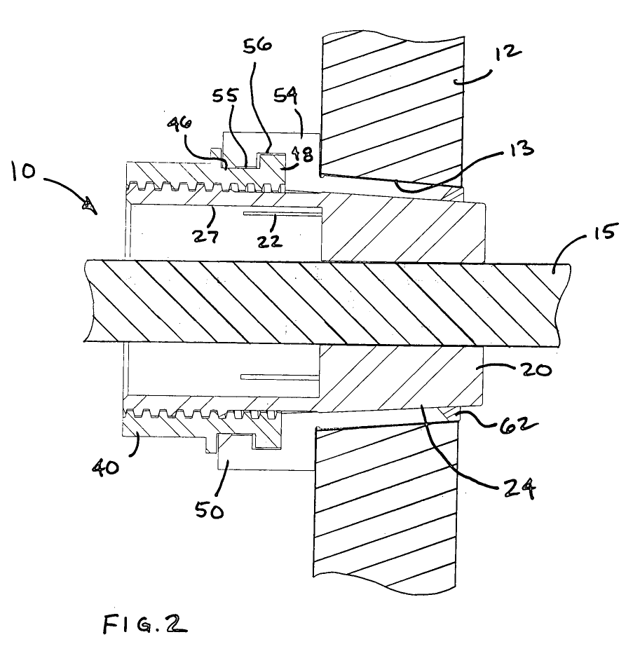

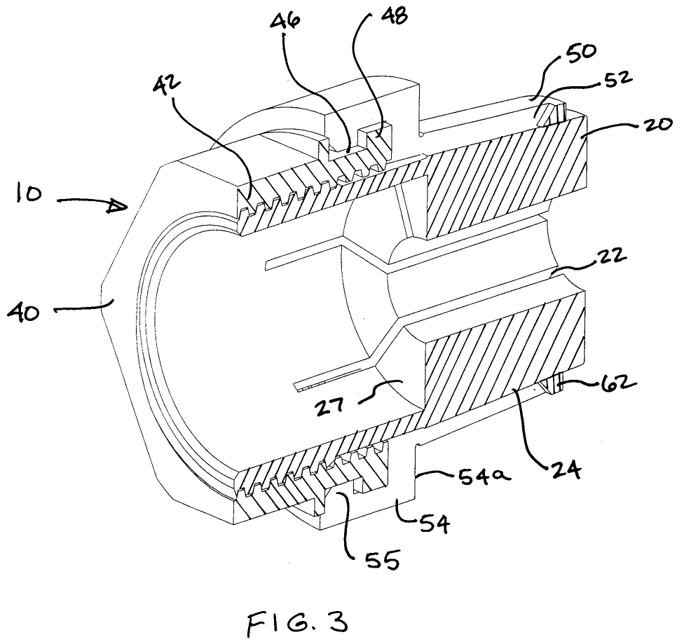

Although the bore of the inner sleeve 20 is generally cylindrical to cooperate with the shaft, preferably, the bore includes an enlarged diameter portion, as shown in FIGS. 2-3. More specifically, preferably the bore in the portion of the inner sleeve that extends rearwardly from the frustoconical portion 24 has a larger diameter than the bore of the inner sleeve in the portion of the sleeve that is co-extensive with the frustoconical portion. The length of the enlarged diameter bore can be shorter than described above, however, preferably the enlarged bore is at least co-extensive with the portion of the inner sleeve extending from the rearward edge to a line demarking the termination of slots 22.

In the present instance, to provide the enlarged bore, a counterbore 27 is formed in the rearward portion of the inner sleeve. The forward edge of the counterbore 27 is formed by a shoulder. Preferably, the counterbore is larger than the diameter of the bore adjacent the forward end of the inner sleeve.

As discussed further below, the inner sleeve engages the shaft 15 by contracting so that the inner sleeve grips or clamps down onto the shaft. For this purpose, the inner sleeve 20 is formed into a plurality of segments by slots 22 that extend longitudinally through the sleeve from the forward end. The slots 22 allow radial deflection of the inner sleeve as the mounting device is tightened or released. Preferably, the slots terminate along a line spaced inwardly from the rearward end of the inner sleeve 20. In this way, the free end portion of the threaded end of the inner sleeve 20 is an unsplit solid continuous ring portion. This solid portion of the inner sleeve provides greater thread strength and improved threaded engagement with the nut 40, relative to a sleeve that is split along the entire axial length. In the present instance, the inner sleeve is made from 1215 steel and provided with six equally spaced slots approximately 5/64″ in width. It will be recognized, however, that the number of slots, as well as the width, length and spacing of the slots can be varied to achieve the desired flexibility.

The inner sleeve 20 is adapted to fit within the outer sleeve 50, which is a unitary sleeve having a plurality of axial slots 52 extending from the rearward end of the outer sleeve. The axial slots 52 permit radial deflection of the outer sleeve 50 as the mounting device 10 is tightened and released. The outer surface of the outer sleeve 50 has an engaging surface 53 that is configured to cooperate with the internal bore 13 of the machine element 12. For example, if the machine element bore 13 is cylindrical, the engaging surface 53 of the outer sleeve is also generally cylindrical. In the present instance, the engaging surface 53 of the outer sleeve is frustoconical to cooperate with a machine element having a tapered bore 13. The minor diameter of the frustoconical surface is adjacent the forward end of the outer sleeve 50 and the major diameter is spaced rearwardly. In other words, the largest diameter of the frustoconical surface 53 is located intermediate the ends of the outer sleeve and the surface tapers inwardly as the surface extends toward the forward end of the outer sleeve. In addition, preferably the engaging surface 53 is sufficiently smaller than the bore 13 of the machine element to permit free sliding movement between the machine element and the outer sleeve when the mounting device is not tightened.

As shown in FIG. 2, 4, the inner surface of the outer sleeve 50 is configured to cooperate with the external surface of the inner sleeve. The inner and outer sleeves have mating tapered surfaces that cooperate to wedge the outer sleeve outwardly while contracting the inner sleeve inwardly. More specifically, the inner surface of the outer sleeve 50 tapers toward the forward end at the same angle of taper as the frustoconical portion 24 of the inner sleeve 20. In other words, the bore of the outer sleeve is tapered so that the minor diameter of the bore is adjacent the forward end of the outer sleeve and the major diameter of the bore is spaced rearwardly from the forward end. In this way, when the inner sleeve 20 is displaced forwardly relative to the outer sleeve 50 (i.e. from left to right in FIG. 2), the confronting tapered surfaces of the inner and outer sleeves cooperate to expand the external tapered surface of the outer sleeve and contract the internal cylindrical surface of the inner sleeve 20. In addition, since the inner and outer sleeves are coaxial, the contraction and expansion of the inner and outer sleeve surfaces is substantially parallel to the common central axis of the assembly.

Preferably, an external circumferential flange 54 is formed on the outer sleeve 50, adjacent the rearward end of the outer sleeve. The flange 54 has an outer diameter that is larger than the major diameter of the engaging surface 53. In this way, the forward shoulder 54a of the flange 54 is configured to abut the side of the machine element to operate as a stop limiting displacement between outer sleeve and the machine element when the mounting device 10 is tightened.

In addition to the external flange 54, an internal circumferential flange 55 extends radially inwardly from the rearward end of the outer sleeve 50. An annular groove 56 extends circumferentially about the inner surface of the outer sleeve 50 adjacent the internal flange 55. As discussed further below, the nut 40 engages the groove 56 to connect the nut to the outer sleeve 50.

The outer sleeve 50 is displaced relative to the inner sleeve 20 by the nut 40. To this end, as illustrated in FIGS. 2-4, the nut 40 has internal threads 42 that threadedly engage the threads 25 of the inner sleeve 20. Rotating the nut 40 axially displaces the inner sleeve relative to the nut. Accordingly, since the outer sleeve 50 is connected to the nut, the inner sleeve is displaced relative to the outer sleeve as the nut is rotated.

The nut 40 has an internal bore that is larger than the diameter of the shaft 15. In addition, preferably the outer diameter of the nut is smaller than the outer diameter of the outer sleeve 50. However, in some applications the nut may be larger in diameter than the outer sleeve without affecting the use of the device, particularly when the device is configured to mount a tapered bore machine element, as in the present instance.

As discussed above, the nut is connected to the outer sleeve to impede substantial axial displacement between the nut and the outer sleeve. To provide a connection between the nut 40 and the outer sleeve 50, the nut is provided with an external circumferential flange 48 that extends radially outwardly, and an external circumferential groove 46 adjacent the flange. Preferably, the forward and rearward sidewalls of the groove 46 are substantially perpendicular to the common axis of the assembly. The external nut flange 48 and circumferential groove 46 cooperate with the internal flange 55 and annular groove 56 of the outer flange.

Specifically, the external flange 48 of the nut engages the annular groove 56 of the outer sleeve, and the internal flange 55 of the outer sleeve engages the circumferential groove 46 of the nut. Accordingly, the external flange 48 of the nut has a width slightly less than the width of the internal groove 56 of the outer sleeve, and the internal flange 55 of the outer sleeve has a width slightly less than the width of the circumferential groove 46 of the nut. In this way, the rearward face of the external nut flange 48 confronts the rearward face of the annular groove 56 of the outer sleeve effecting rearward axial force on the outer sleeve 50 when the nut is rotated to drive the inner sleeve forwardly relative to the nut. Similarly, the forward face of the external nut flange 48 confronts the forward face of the annular groove 56 of the outer sleeve, and the rearward face of the internal flange 55 of the outer sleeve confronts the rearward face of the circumferential groove around the nut 40 effecting forceful forward axial force on the outer sleeve when the nut is rotated to drive the inner sleeve rearwardly relative to the nut.

The inner diameter of the internal flange 55 of the outer sleeve is smaller than the outer diameter of the external flange 48 on the nut, and the internal flange on the outer sleeve must pass over the nut flange to connect the outer sleeve to the nut. Therefore, to connect the one-piece outer sleeve 50 to the nut 40, the outer sleeve must be sufficiently flexible to allow the outer sleeve to expand over the outwardly extending flange of the nut. Accordingly, the outer sleeve 50 is formed into a plurality of segments by means of slots 52 that extend axially longitudinally of the sleeve from the rearward end. All of the slots 52 terminate along a line spaced inwardly from the forward end of the outer sleeve 50, except for slot that extends through the entire length of the outer sleeve.

The termination of the slots 52, in conjunction with the through-slot provide a split web 62 joining the segments at the forward end. In the present instance, the inner sleeve is made from 1215 steel and provided with six equally spaced slots approximately 5/64″ in width, five of which are terminated slots, and one of which is the through slot. It will be recognized, however, that the number of slots, as well as the width, length and spacing of the slots can be varied to achieve the requisite flexibility. As seen most clearly in FIG. 3, the terminated slots 22 terminate just prior to forward end of the outer sleeve, so that the web 62 is thickest at the forward end of the outer sleeve, tapering inwardly as the web extends toward the rearward end of the outer sleeve. In this way, the axial length of the web 62 at the forward end is sufficiently small to allow the outer sleeve to deflect radially to connect the outer sleeve to the nut.

The mounting device 10 is assembled as follows. The nut 40 is threaded onto the inner sleeve 20. The outer sleeve 50 is connected to the nut 40 by sliding the outer sleeve over the inner sleeve 20 until the internal flange 55 on the outer sleeve engages the external flange 48 of the nut. Because the outer sleeve slides over the inner sleeve during assembly, preferably the nut it threaded onto the inner sleeve a sufficient distance so that the mating frustoconical surfaces 24, 53 of the inner and outer sleeves do not engage each other during assembly.

After sliding the outer sleeve 50 over the inner sleeve 20, the outer sleeve is connected to the nut 40 by driving the outer sleeve over the nut as follows. As the outer sleeve engages the nut, the outer sleeve flexes and expands radially outwardly over the nut flange 48. To facilitate the radial expansion, the rearward face of the internal flange 55 of the outer sleeve is chamfered as illustrated in FIG. 2. The outer sleeve is displaced rearwardly relative to the nut until the internal flange 55 of the outer sleeve is displaced past the external nut flange 48. The outer sleeve then resiliently contracts so that the internal flange 55 of the outer sleeve is engaged in the circumferential groove 46 around the nut, and the external nut flange 48 is engaged in the annular groove 56 in the outer sleeve. In this way, the outer sleeve 50 is captively entrained by the nut 40.

Configured as described above, the mounting device 10 operates as follows. The device 10 is mounted onto a first element, such as a shaft 15, by sliding the device over the shaft so that the shaft slides through the inner bore of the inner sleeve 20 and the bore of the nut 40. A second element, such as a machine element 12 is then mounted onto the device by sliding the machine element over the shaft and then over the mounting device so that the outer surface of the outer sleeve 50 engage the bore 13 of the machine element. Preferably, the machine element is positioned onto the mounting device 10 so that the side of the machine element abuts the forward shoulder of the external flange 54 on the outer sleeve 50. Alternatively, the mounting device 10 can be inserted into the bore 13 of the machine element first and the two can be slid onto the shaft 15 together. Either way, the mounting device is positioned on the shaft so that the bore of the inner sleeve 20 confronts the shaft and the external engaging surface 53 of the outer sleeve 50 confronts the bore of the machine element 12.

To lock the machine element onto the shaft, the nut is rotated. As can be seen in FIG. 2, the wedging action of the inner and outer sleeves is provided by displacing the inner sleeve forward relative to the outer sleeve. Specifically, when the device is in a loosened position, the inner sleeve is located within the outer sleeve so that the major diameter of the inner sleeve frustoconical portion 24 is positioned within a portion of the outer sleeve bore having a diameter that is at least as great as the major diameter of the inner sleeve frustoconical portion. In other words, in the loosened position, the inner sleeve 20 does not contact the bore of the outer sleeve to provide a wedging or clamping force.

Rotating the nut 40 in a forward direction displaces the inner sleeve 20 forwardly relative to the outer sleeve 50 so that the tapered surface of the frustoconical portion of the inner sleeve is driven through the inner tapered bore of the outer sleeve. Because the outer sleeve tapers inwardly to a smaller diameter bore at the forward end, driving the inner sleeve forwardly wedges the outer sleeve so that the outer sleeve deflects radially outwardly to expand the outer sleeve in the bore 13 of the machine element to lock onto the machine element. At the same time, the wedging force deflects the inner sleeve radially inwardly so that the inner sleeve contracts to lock the inner sleeve onto the shaft. To release the connection between the machine element, mounting device and shaft, the nut is simply rotated in a reverse direction. The reverse rotation displaces the inner sleeve rearwardly relative to the outer sleeve. The rearward relative displacement of the inner sleeve draws the major diameter of the inner sleeve frustoconical portion 24 into the larger diameter portion of the outer sleeve tapered bore, which in turn releases the wedging force provided by the interfering tapered surfaces. In this way, rotating the nut in the reverse direction loosens the outer sleeve from the machine element and loosens the inner sleeve from the shaft.

As described above, preferably the nut is rotated in a forward direction to tighten the mounting device. Preferably, the cooperating threads 25, 42 of the inner sleeve 20 and the nut 40 are left-handed threads. In this way, rotating the nut 40 in a clockwise direction drives the inner sleeve forward relative to the outer sleeve to tighten the device. In other words, by using left-handed threads, the forward direction is clockwise and the reverse direction is counter-clockwise.

The angle of taper of the external surface of the inner sleeve 20 and the internal surface of the outer sleeve 50 is selected relative to the length of the threaded portion 52 of the outer sleeve. A more shallow angle permits greater displacement of the outer sleeve 50 relative to the inner sleeve 20 with less expansion of the mounting device 10. Alternatively, a sharper angle reduces the relative displacement of the sleeves before expansion of the device.

The mounting device is particularly effective to avoid damage to the shaft and the machine elements in case of catastrophic overload of the machine. A major advantage of the construction of the invention is that it slips and protects other elements of the machine without damage to the shaft or the machine element. In the event of slippage due to excess loading, the unit itself may not be damaged and may be used without replacement or readjustment. The construction also enables the units to be fabricated from materials other than metal where the operating conditions are such as to limit the selection of the material used in fabricating the parts.

The use of a single-piece inner sleeve in conjunction with a single piece outer sleeve is particularly suited for situation in which precise rotary balance is required. In known devices incorporating a multiple piece inner or outer sleeve, the pieces comprising the multiple piece sleeve can move relative to one another when the device is tightened or loosened, thereby altering the rotational balance of the device. By eliminating the multiple piece sleeve, the present mounting device reduces rotary imbalance during use of the device. In this way, the device can be circumferentially balanced during manufacture, and the device will retain the balance during normal operation.

It will be recognized by those skilled in the art that changes or modifications can be made to the above-described embodiments without departing from the broad inventive concept of the invention. It should therefore be understood that this invention is not limited to the particular embodiments described herein but is intended to include all changes and modifications that are within the scope and spirit of the invention as set forth in the following claims.

1. A device for coaxially mounting a machine element having a bore upon a shaft comprising:
a nut having threads and a first connector;
an outer sleeve for engaging the machine element, comprising:
a tapered external surface;
a tapered internal surface wherein the internal surface has a minor diameter adjacent a forward end of the outer sleeve and a major diameter spaced rearwardly from the forward end;
at least one axial slot extending longitudinally along the outer sleeve to permit expansion of the external surface of the outer sleeve;
a second connector cooperable with the first connector to connect the outer sleeve with the nut to impede substantial axial displacement of the outer sleeve relative to the nut while allowing rotation of the outer sleeve relative to the inner sleeve;
an inner sleeve for encircling the shaft, comprising:
a tapered external surface corresponding in angle of taper to the tapered internal surface of the outer sleeve and having a minor diameter adjacent a forward end of the inner sleeve and a major diameter spaced rearwardly from the forward end of the inner sleeve;
an interior bore corresponding in diameter to the shaft; and
a threaded portion remote from the forward end of the inner sleeve and cooperable with the threaded portion of the nut;
wherein rotating the nut in a first direction displaces the inner sleeve forwardly relative to the nut, which displaces the major diameter of the external surface of the inner sleeve toward the minor diameter of the outer sleeve internal surface, thereby causing the inner sleeve to contract against the shaft and the outer sleeve to expand against the bore of the machine element, and wherein rotating the nut in a second direction displaces the inner sleeve rearwardly relative to the nut, thereby loosening the inner sleeve from the shaft and the outer sleeve from the bore of the machine element.

2. The device of claim 1 wherein the outer sleeve comprises a plurality of axial slots extending longitudinally along the outer sleeve, wherein the configuration and orientation of the slots provide sufficient radial flexibility to allow the outer sleeve to deflect to fit over the first connector of the nut.

3. The device of claim 2 wherein the first connector comprises a circumferential groove and the second connector comprises a flange extending radially inwardly, wherein said outer sleeve is sufficiently resilient such that the outer sleeve contracts after flexing to fit the flange into the groove.

4. The device of claim 1 wherein the external surface of the outer sleeve has a minor diameter and the nut has an external diameter that is greater than the minor diameter of the outer sleeve external diameter.

5. The device of claim 1 wherein the external surface of the outer sleeve has a major diameter and the outer sleeve comprises an external flange extending radially outwardly adjacent the major diameter of the outer sleeve external surface.

6. The device of claim 1 wherein one end of the inner sleeve is continuous about the circumference.

7. The device of claim 1 wherein the outer sleeve is a one-piece sleeve comprising a plurality of slots forming a plurality of sections connected by a web that allows the outer sleeve to resiliently deflect radially.

8. The device of claim 1 wherein the outer sleeve comprises a stop engageable with the machine element to impede relative axial displacement between the outer sleeve and the machine element.

9. A device for coaxially mounting a machine element having a bore upon a shaft comprising:
a one-piece inner sleeve for encircling the shaft, having a forward and rearward end, wherein the inner sleeve comprises:
a threaded portion adjacent the rearward end;
a frustoconical external surface having a major diameter adjacent the threaded portion and a minor diameter spaced from the major diameter toward the forward end of the inner sleeve;
an internal bore configured to cooperate with the shaft;
a nut having threads at one end and a circumferential flange at the distal end;
an outer sleeve engaging the machine element, having a forward end and a rearward end, wherein the outer sleeve comprises:
a frustoconical internal surface corresponding in angle of taper to the tapered external surface of the inner sleeve, and having a major diameter adjacent the rearward end and a minor diameter adjacent the forward end;
an external surface corresponding to the bore of the machine element; and
a circumferential interlock engaging the flange of the nut;
wherein upon rotation of the nut, the threads of the nut engage with the threads of the inner sleeve displacing the inner sleeve in one direction relative to the nut and the outer sleeve thereby displacing the major diameter of the inner sleeve external surface toward the minor diameter of the outer sleeve internal surface, the displacements causing the internal bore of the inner sleeve to contract against the shaft and the external surface of the outer sleeve to expand against the bore of the machine element.

10. The device of claim 9 wherein the flange extends radially outwardly and the nut further comprises an annular groove adjacent the flange, wherein the outer sleeve is a one piece sleeve having sufficient resilience such that the outer sleeve contracts after flexing to fit over the flange thereby displacing the circumferential interlock into engagement with the circumferential groove.

11. The device of claim 9 wherein the outer sleeve comprises a frustoconical external surface having a minor diameter adjacent the forward end of the outer sleeve and a major diameter spaced rearwardly from the minor diameter.

12. The device of claim 11 wherein the nut has an external diameter that is greater than the major diameter of the outer sleeve external surface.

13. The device of claim 9 wherein the outer sleeve comprises a stop engageable with the machine element to impede relative axial displacement between the outer sleeve and the machine element.

14. The device of claim 9 wherein one end of the inner sleeve is continuous about the circumference.

15. A method for mounting a machine element onto a shaft, comprising the steps of:
providing an inner sleeve having forward and rearward ends, comprising:
a tapered external surface
a threaded portion adjacent the rearward end; and
a bore that is cooperable with the shaft;
providing an outer sleeve comprising:
an internal bore that is tapered to cooperate with the external surface of the inner sleeve; and
an external surface cooperable with the bore of the machine element;
providing a nut having a threaded portion that is cooperable with the threaded portion of the inner sleeve;
connecting the outer sleeve to the nut to impede substantial axial displacement of the outer sleeve relative to the nut while allowing rotation of the nut relative to the outer sleeve;
positioning the inner sleeve and the outer sleeve between the shaft and the bore of the machine element;
rotating the nut in a forward direction to drive the inner sleeve forwardly relative to the nut and the outer sleeve thereby displacing the forward end of the inner sleeve away from the nut, so that the tapered surface of the inner sleeve wedges apart the outer sleeve to connect the outer sleeve to the machine element and to connect the inner sleeve to the shaft;
wherein rotating the nut in a reverse direction drives the inner sleeve rearwardly relative to the nut and outer sleeve to release the outer sleeve from the machine element and to release the inner sleeve from the shaft.

16. The method of claim 15 wherein the tapered bore of the outer sleeve comprises a minor diameter adjacent the forward end of the outer sleeve, remote from nut, and the step of rotating the nut in the forward direction drives the inner sleeve through the minor diameter.

17. The method of claim 15 wherein the nut comprises a first interlocking element and the outer sleeve comprises a second interlocking element and the step of connecting the outer sleeve to the nut comprises driving the outer sleeve toward the nut so that the outer sleeve deflects radially so that the second interlocking element rides over the first interlocking element.

18. The method of claim 17 wherein the outer sleeve resiliently displaces radially after the second interlocking element rides over the first interlocking element, thereby interlocking the first and second interlocking elements.
